(19) United States
(12) Patent Application Publication
(10) Pub. No.: US 2025/0287417 A1
(43) Pub. Date: Sep. 11, 2025

(54) COMMUNICATION METHODS AND APPARATUSES, AND STORAGE MEDIUM AND CHIP

(71) Applicant: Beijing Xiaomi Mobile Software Co., Ltd., Beijing (CN)

(72) Inventor: Yajun ZHU, Beijing (CN)

(73) Assignee: Beijing Xiaomi Mobile Software Co., Ltd., Beijing (CN)

(21) Appl. No.: 18/859,475

(22) PCT Filed: Apr. 29, 2022
(86) PCT No.: PCT/CN2022/090720

§ 371 Date: Oct. 23, 2024

(51) Int. Cl. H04W 74/00; H04B 7/06; H04W 74/0836; H04W 84/06

(52) U.S. Cl. CPC H04W 74/004; H04B 7/06956; H04W 74/0836; H04W 84/06

(57) ABSTRACT

The present disclosure relates to communication methods and apparatuses, and a storage medium and a chip. A communication method includes: determining a first polarization parameter of the terminal device; and sending a first access message to a network device according to the first polarization parameter. The first access message is configured to indicate the network device to obtain the first polarization parameter according to the first access message.

### CROSS REFERENCE TO RELATED APPLICATION

The present application is a U.S. National Stage of International Application No. PCT/CN2022/090720, filed on Apr. 29, 2022, the contents of which are incorporated herein by reference in its entirety.

### TECHNICAL FIELD

The present disclosure relates to the field of communication technologies, and in particular, to a communication method, a communication apparatus, a storage medium and a chip.

### BACKGROUND

With the developments of communication technologies, wireless communication systems can be formed by heterogeneous networks of various standards. For example, the heterogeneous networks may include the 4th Generation mobile communication networks (4G), the 5^{th} Generation mobile communication networks (5G) and Non-Terrestrial Networks (NTN), etc.

NTN may use satellite equipment to provide network services for terminals, such as a synchronous earth orbit satellite, a low earth orbit satellite, a high elliptical orbit satellite, a high-altitude platform station (haps), etc. The antenna(s) on satellite equipment in NTN may use an antenna of a circular polarization type, while antennas in 5G networks and 4G networks may use antennas of a linear polarization type. Antenna(s) of a terminal may be the circular polarization type or the linear polarization type. When the polarization types of a terminal antenna and a base station antenna do not match, polarization loss will occur. At this time, the network device needs to obtain the antenna polarization parameter(s) of the terminal in time, so as to compensate for the polarization loss through specific processing to avoid degradation of communication quality due to the mismatch of polarization types.

However, in the related art, the terminal cannot report the antenna polarization parameter(s) to the network device in time.

### SUMMARY

In order to overcome the above problems existing in the related art, the present disclosure provides a communication method, a communication apparatus, a storage medium and a chip.

According to a first aspect of an embodiment of the present disclosure, a communication method is provided. The method is applied in a terminal device, and the method includes:
determining a first polarization parameter of the terminal device; and
sending a first access message to a network device according to the first polarization parameter, wherein the first access message is configured to indicate the network device to obtain the first polarization parameter according to the first access message.

According to a second aspect of an embodiment of the present disclosure, a communication method is provided. The method is applied in a network device, and the method includes:
receiving a first access message, wherein the first access message is a message sent by a terminal device to the network device according to a first polarization parameter of the terminal device to request access to the network device; and
obtaining the first polarization parameter of the terminal device according to the first access message.

According to a third aspect of an embodiment of the present disclosure, a communication apparatus is provided. The communication apparatus is applied in a terminal device, and the apparatus includes:
a first parameter determination module configured to determine a first polarization parameter of the terminal device; and
a first message sending module configured to send a first access message to the network device according to the first polarization parameter, wherein the first access message is configured to indicate the network device to obtain the first polarization parameter according to the first access message.

According to a fourth aspect of an embodiment of the present disclosure, a communication apparatus is provided. The communication apparatus is applied in a network device, and the apparatus includes:
a first message receiving module configured to receive a first access message, wherein the first access message is a message sent by a terminal device to the network device according to a first polarization parameter of the terminal device to request access to the network device; and
a first parameter obtaining module configured to obtain the first polarization parameter of the terminal device according to the first access message.

According to a fifth aspect of an embodiment of the present disclosure, a terminal device is provided, including:
a processor; and
a memory configured to store instructions executable by the processor;
wherein the processor is configured to perform steps of the communication method provided in the first aspect of the present disclosure.

According to a sixth aspect of an embodiment of the present disclosure, a network device is provided, including:
a processor; and
a memory configured to store instructions executable by the processor;
wherein the processor is configured to perform steps of the communication method provided in the second aspect of the present disclosure.

According to a seventh aspect of an embodiment of the present disclosure, a computer-readable storage medium is provided, on which computer program instructions are stored. When the computer program instructions are executed by a processor, the steps of the communication method provided in the first aspect of the present disclosure are implemented.

According to an eighth aspect of an embodiment of the present disclosure, a computer-readable storage medium is provided, on which computer program instructions are stored. When the computer program instructions are executed by a processor, the steps of the communication method provided in the second aspect of the present disclosure are implemented.

According to a ninth aspect of an embodiment of the present disclosure, a chip is provided, including: a processor and an interface; the processor is configured to read instructions to perform the steps of the communication method provided in the first aspect of the present disclosure,

According to a tenth aspect of an embodiment of the present disclosure, a chip is provided, including: a processor and an interface; the processor is configured to read instructions to perform the steps of the communication method provided in the second aspect of the present disclosure.

It is to be understood that the foregoing general description and the following detailed description are illustrative and explanatory only and are not restrictive of the present disclosure.

### BRIEF DESCRIPTION OF THE DRAWINGS

The accompanying drawings, which are incorporated in and constitute a part of the specification, illustrate embodiments consistent with the present disclosure and, together with the specification, serve to explain the principles of the present disclosure.

FIG. 1 is a schematic diagram showing a communication system according to an example embodiment.

FIG. 2 is a flowchart showing a communication method according to an example embodiment.

FIG. 3 is a flowchart showing a communication method according to an example embodiment.

FIG. 4 is a flowchart showing a communication method according to an example embodiment.

FIG. 5 is a flowchart showing a communication method according to an example embodiment.

FIG. 6 is a flowchart showing a communication method according to an example embodiment.

FIG. 7 is a flowchart showing a communication method according to an example embodiment.

FIG. 8 is a flowchart showing a communication method according to an example embodiment.

FIG. 9 is a flowchart showing a communication method according to an example embodiment.

FIG. 10 is a flowchart showing a communication method according to an example embodiment.

FIG. 11 is a block diagram of a communication apparatus according to an example embodiment.

FIG. 12 is a block diagram of a communication apparatus according to an example embodiment.

FIG. 13 is a block diagram of a communication apparatus according to an example embodiment.

FIG. 14 is a block diagram of a communication apparatus according to an example embodiment.

FIG. 15 is a block diagram of a communication apparatus according to an example embodiment.

FIG. 16 is a block diagram of a communication apparatus according to an example embodiment.

FIG. 17 is a block diagram of a communication apparatus according to an example embodiment.

FIG. 18 is a block diagram of a communication apparatus according to an example embodiment.

### DETAILED DESCRIPTION

Example embodiments will be described in detail herein, examples of which are shown in the accompanying drawings. When the following description refers to the drawings, the same numbers in different drawings represent the same or similar elements unless otherwise indicated. The embodiments described in the following example embodiments do not represent all embodiments consistent with the present disclosure. Instead, they are merely examples of devices and methods consistent with some aspects of the present disclosure as detailed in the appended claims.

It should be noted that all actions of obtaining signals, information or data in the present disclosure are carried out in compliance with relevant data protection laws and policies of the country where a device is located and with the authorization given by the corresponding owner of the device.

The terms such as “first”, “second”, etc. used in the present disclosure are used to distinguish similar objects and are not necessarily understood as a specific order or sequence. In addition, in the description with reference to the accompanying drawings, the same symbol in different drawings represents the same element unless otherwise specified.

In the description of the present disclosure, unless otherwise specified, “and/or” is a description of an association relationship of associated objects, indicating that three relationships may exist. For example, A and/or B can represent: A exists alone, A and B exist at the same time, and B exists alone, where A and B can be singular or plural. In addition, in the description of the present disclosure, unless otherwise specified, “multiple” refers to two or more than two. The expression “at least one of the following items . . . ” or similar expression refers to any combination of these items, including any combination of single or plural items. For example, at least one of a, b or c can represent: a, b, c, ab, ac, bc, or abc, where a, b, c can be single or plural.

First, an application scenario of the present disclosure is described. The present disclosure can be applied to a wireless communication scenario, especially wireless communication in a networking scenario where the antenna polarization types of a terminal device and a network device are different. The antenna polarization types may include linear polarization and circular polarization, which are described as follows:

Linear polarization: an electromagnetic wave with a fixed orientation of an electric field vector in space is called linear polarization. With the horizontal line of the ground as a reference, linear polarization may be divided into two types: horizontal polarization and vertical polarization. The direction of the electric field vector parallel to the ground is called horizontal polarization, and the direction of the electric field vector perpendicular to the ground is called vertical polarization.

Circular polarization: when the angle between the polarization plane of an electromagnetic wave and the normal plane of the earth changes periodically from 0 to 360°, that is, the magnitude of the electric field remains unchanged, the direction changes with time, and the trajectory of the end of the electric field vector is projected as a circle on a plane perpendicular to the propagation direction, it is called circular polarization. Circular polarization means a rotating electromagnetic wave radiated by an antenna around the propagation direction along a circular path as the wave propagates forward. The circular polarization includes right-hand circular polarization (Right-Hand Circularly Polarized, RHCP) or left-hand circular polarization (Left-Hand Circularly Polarized, LHCP).

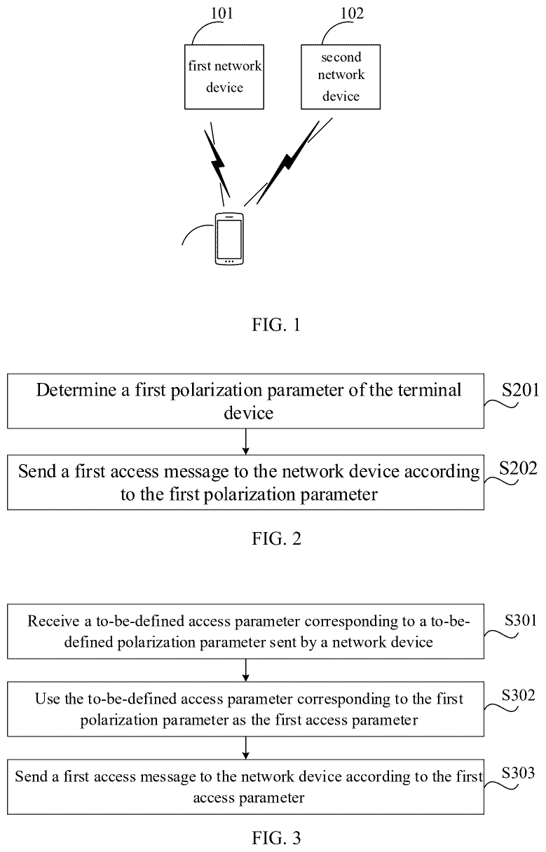

FIG. 1 is a schematic diagram of a communication system according to an example embodiment. The communication system may include a first network device 101, a second network device 102, and a terminal device 103. The antenna polarization types of the first network device 101 and the second network device 102 may be different, and the antenna polarization type of the terminal device 103 may be a circular polarization type or a linear polarization type.

For example, the antenna polarization type of the first network device 101 is a circular polarization type, the antenna polarization type of the second network device 102 is a linear polarization type, and the antenna polarization type of the terminal device 103 may be a linear polarization type. When the terminal device 103 communicates with the second network device 102, the antenna polarization types of the terminal device and the second network device are consistent, and there will be no polarization loss, and normal communication is possible. However, when the terminal device 103 communicates with the first network device 101, the antenna polarization types of the terminal device and the first network device are different, and polarization loss will occur. The terminal device may send UE capability information to the network device(s), and report an antenna polarization parameter (e.g., a first polarization parameter) of the terminal device in the UE capability information. However, since the UE capability information needs to be sent through an RRC message after the terminal device and the network device establish an Radio Resource Control (RRC) connection, the terminal device cannot report the antenna polarization parameter in a timely manner, and the first network device cannot know the antenna polarization parameter of the terminal device, and thus cannot perform specific processing (such as retransmission) to compensate for the polarization loss.

In order to solve the above problem, the present disclosure provides a communication method, a communication apparatus, a storage medium and a chip. A terminal device can send a first access message to a network device according to a first polarization parameter of the terminal device itself. The first access message can be configured to indicate the network device to obtain the first polarization parameter of the terminal device according to the first access message. In this way, the terminal device can implicitly report the first polarization parameter to the network device, thereby improving the timeliness of reporting the first polarization parameter.

The present disclosure is described below in conjunction with specific embodiments.

FIG. 2 is a communication method according to an example embodiment. The method may be applied to a terminal device, and the terminal device may include a smart phone, a smart wearable device, a smart speaker, a smart tablet, a Personal Digital Assistant (PDA), Customer Premise Equipment (CPE), etc. As shown in FIG. 1, the method may include:

In S201, a first polarization parameter of the terminal device is determined.

For example, the antenna polarization type of the terminal device may be obtained, and the antenna polarization type may be used as the first polarization parameter; or a specific parameter preset according to the antenna polarization type of the terminal device may be used as the first polarization parameter.

In S202, a first access message is sent to the network device according to the first polarization parameter.

The first access message may be configured to indicate the network device to obtain the first polarization parameter of the terminal device according to the first access message.

It should be noted that the first access message may be used by the terminal device to request access to the network device, and may also indicate the network device to process the access request of the terminal according to the first access message.

In some embodiments, the first access message may include an RA preamble (Random Access preamble, also referred to as Msg1), and the first access message may be sent via a Physical Random Access Channel (PRACH). The terminal device may determine a PRACH resource corresponding to the first access message according to the first polarization parameter, and different first polarization parameters may correspond to different PRACH resources. In this way, the network device can also obtain the first polarization parameter of the terminal device according to the PRACH resource corresponding to the first access message.

In some other embodiments, in a two-step random access (2-stePRACH) scenario, the first access message may include MsgA, which may also be called a preamble.

By adopting the above method, the terminal device can send the first access message to the network device according to the first polarization parameter of the terminal device itself. The first access message can be configured to indicate the network device to obtain the first polarization parameter of the terminal device according to the first access message. In this way, the terminal device can implicitly report the first polarization parameter to the network device without adding a new field in the first access message, thereby improving the timeliness of the first polarization parameter reporting.

In some embodiments, the first polarization parameter may be used to represent the antenna polarization type of the terminal device, and the antenna polarization type may be the polarization capability or polarization mode of an antenna of the terminal device. The antenna polarization type may include a circular polarization type and/or a linear polarization type. Further, the circular polarization type may include RHCP and/or LHCP, and the linear polarization type may include horizontal polarization and/or vertical polarization.

For example, when the antenna polarization type is the linear polarization type, the terminal device may determine a first PRACH resource corresponding to the linear polarization type, and transmit the first access message through the first PRACH resource. The network device may obtain the antenna polarization type of the terminal device which is the linear polarization type based on the first PRACH resource for receiving the first access message.

Similarly, when the antenna polarization type is the circular polarization type, the terminal device may determine a second PRACH resource corresponding to the circular polarization type, and transmit the first access message through the second PRACH resource. The network device may obtain the antenna polarization type of the terminal device which is a circular polarization type based on the second PRACH resource for receiving the first access message.

In this way, the terminal device implicitly reports the antenna polarization type by the PRACH resource for transmitting the first access message.

It should be noted that although the present disclosure uses linear polarization and circular polarization as examples, the present disclosure does not limit the antenna polarization type. For example, the antenna polarization type may also be other types than the above two polarization types, such as elliptical polarization, or polarization at a certain angle in linear polarization except the horizontal polarization and the vertical polarization.

FIG. 3 is a communication method according to an example embodiment. The method may be applied to a terminal device. The method may include:

In S301, a to-be-defined access parameter corresponding to a to-be-defined polarization parameter sent by a network device is received.

The to-be-defined polarization parameter may include the first polarization parameter, and the to-be-defined access parameter may also include a to-be-defined access parameter corresponding to the first polarization parameter. There may be one or more to-be-defined polarization parameters.

In S302, the to-be-defined access parameter corresponding to the first polarization parameter is used as the first access parameter.

In S303, a first access message is sent to the network device according to the first access parameter.

The above access parameter (the to-be-defined access parameter or the first access parameter) may represent a PRACH resource used to transmit the first access message. The PRACH resource may include one or more of the following resources: a physical random access channel root sequence (prach-RootSequence), a physical random access channel transmission occasion RO resource (PRACH transmission occasion, also referred to as PRACH occasion, or RO resource for short), or a random access channel power resource, etc.

In some embodiments, different to-be-defined polarization parameters may correspond to different to-be-defined access parameters. For example, if the to-be-defined polarization parameter represents that the antenna polarization type of the terminal device is the linear polarization type, the to-be-defined access parameter corresponding to the linear polarization type may be a first to-be-defined access parameter, and the first to-be-defined access parameter may represent that the first access message may be transmitted using a first PRACH resource. Conversely, if the to-be-defined polarization parameter represents that the antenna polarization type of the terminal device is the circular polarization type, the to-be-defined access parameter corresponding to the circular polarization type may be a second to-be-defined access parameter, and the second to-be-defined access parameter may characterize that the first access message may be transmitted using a second PRACH resource.

In this way, the terminal device can determine the first access parameter based on the to-be-defined access parameter received from the network device, and send the first access message to the network device according to the first access parameter. The network device also determines the first access parameter based on the first access message, and determines the first polarization parameter of the terminal device according to the first access parameter. Through the interaction between the network device and the terminal device, the compatibility of the network device and the terminal device can be improved.

In some embodiments, the to-be-defined access parameter include one or more of the following parameters:

Parameter 1: a to-be-defined physical random access channel root sequence index prach-RootSequenceIndex corresponding to the to-be-defined polarization parameter.

The to-be-defined prach-RootSequenceIndex represents a physical random access channel root sequence index used to transmit the first access message.

Parameter 2: a to-be-defined physical random access channel generic configuration rach-ConfigGeneric corresponding to the to-be-defined polarization parameter.

The to-be-defined rach-ConfigGeneric may include one or more of the following parameters, such as msg1-FDM (of message 1), msg1-FrequencyStart (frequency domain starting position of message 1), preambleReceivedTargetPower (preamble received target power), etc. The RO resource used to send the first access message may be represented by msg1-FDM and msg1-FrequencyStart. The power resource used to send the first access message may be represented by preambleReceivedTargetPower.

Parameter 3: a to-be-defined synchronization signal block shared physical random access channel transmission occasion mask SSB-SharedRO-MaskIndex corresponding to the to-be-defined polarization parameter.

The to-be-defined SSB-SharedRO-MaskIndex can represent the shared RO resource used to send the first access message.

In this way, the PRACH resource for sending the first access message can be determined through the to-be-defined access parameter, and the first access message is sent through the PRACH resource, so that the first polarization parameter of the terminal device can be implicitly reported to the network device.

In some embodiments, the to-be-defined access parameter may be carried in a random access information element, and the random access information element includes one or more of the following information elements:
Information element 1: random access channel common configuration RACH-ConfigCommon information element;
Information element 2: random access channel common configuration information RACH-ConfigCommonTwoStepRA information element for two-step random access;
Information element 3: random access channel dedicated configuration information RACH-ConfigDedicated.

The above Information Elements (IEs) are all information elements used for random access. By carrying the to-be-defined access parameter in the random access information element, the terminal can more conveniently obtain the to-be-defined access parameter.

It should be noted that the above-mentioned to-be-defined access parameter may also be carried in other information fields, which is not limited in the present disclosure.

An existing parameter field in a 3GPP protocol may be reused for the above-mentioned to-be-defined access parameter, or a new parameter field may be added in the 3GPP protocol. For example, two parameters: prach-RootSequenceIndex-A and prach-RootSequenceIndex-B, can be added to the RACH-ConfigCommon information element. The prach-RootSequenceIndex-A may be used to represent the physical random access channel root sequence index corresponding to the linear polarization type, and prach-RootSequenceIndex-B may be used to represent the physical random access channel root sequence index corresponding to the circular polarization type.

In some embodiments, the terminal device may receive the above-mentioned to-be-defined access parameter through a broadcast message, and the broadcast message may include a System Information Block (SIB) message. For example, the to-be-defined access parameter may be carried in the SIB message, and the terminal device may receive the to-be-defined access parameter through the SIB message. In this way, when the terminal device accesses the network device, the terminal device may determine the first access parameter corresponding to the first polarization parameter according to the to-be-defined access parameter received most recently, and send the first access message to the network device according to the first access parameter.

In some other embodiments, the terminal device may receive the above-mentioned to-be-defined access parameter through a UE (User Equipment) dedicated message, and the UE dedicated message may include an RRC message. For example, the to-be-defined access parameter may be carried in an RRC message, and after the terminal device accesses the network device and establishes an RRC connection, the terminal device may receive the first access parameter through an RRC message, and then after the RRC connection is released, when the terminal device accesses the network device again, the terminal device may determine the first access parameter corresponding to the first polarization parameter according to the to-be-defined access parameter received most recently, and send the first access message to the network device according to the first access parameter. The RRC message carrying the to-be-defined access parameter may be an RRC connection release (RRCRelease) message, and/or an RRC reconfiguration (RRCReconfiguration) message.

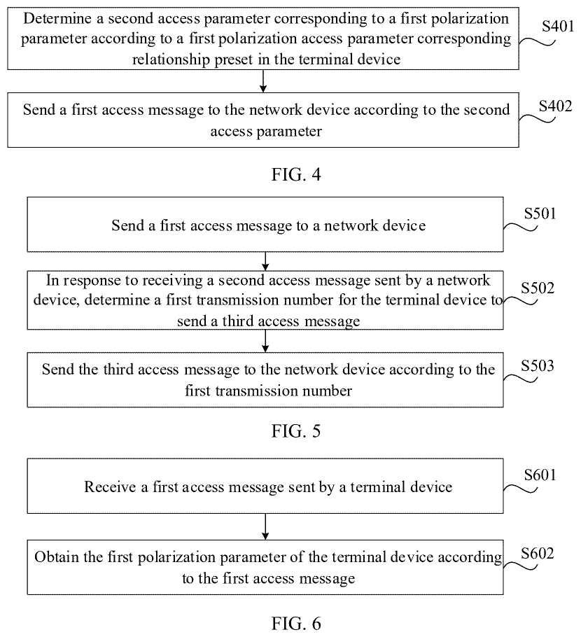

FIG. 4 is a communication method according to an example embodiment. The method may be applied in a terminal device. The method may include:

In S401, a second access parameter corresponding to a first polarization parameter is determined according to a first polarization access parameter corresponding relationship preset in the terminal device.

In S402, a first access message is sent to the network device according to the second access parameter.

The first polarization access parameter corresponding relationship includes a corresponding relationship between the first polarization parameter and the second access parameter, and the first polarization access parameter corresponding relationship is the same as a second polarization access parameter corresponding relationship preset in the network device.

For example, the first polarization access parameter corresponding relationship may include: a second access parameter corresponding to the linear polarization type; and a second access parameter corresponding to a circular polarization type.

In some embodiments, the second access parameter may represent a PRACH resource used to transmit the first access message. The PRACH resource may also include one or more of the following resources: a physical random access channel root sequence (prach-RootSequence), a physical random access channel transmission occasion RO resource (PRACH transmission occasion, also referred to as PRACH occasion, RO resource for short), a random access channel power resource, etc.

In this way, the same polarization access parameter corresponding relationship is preset in the terminal device and the network device, the terminal device sends the first access message according to the second access parameter, the network device can obtain the second access parameter according to the first access message, and obtain the first polarization parameter of the terminal device according to the second access parameter, and thus the terminal device can implicitly report the first polarization parameter.

FIG. 5 is a communication method according to an example embodiment. The method may be applied to a terminal device. The method may include:

In S501, a first access message is sent to a network device.

In this step, the first access message may be sent to the network device according to the first polarization parameter of the terminal device; or a general first access message may be directly sent to the network device without considering the first polarization parameter, which is not limited in this embodiment.

In S502, in response to receiving a second access message sent by a network device, a first transmission number for the terminal device to send a third access message is determined.

In S503, the third access message is sent to the network device according to the first transmission number.

For example, the first access message may include a random access preamble (RA preamble, also referred to as Msg1), the second access message may include a Random Access Response (RAR, also referred to as Msg2), and the third access message may include a Radio Resource Control message (RRC message, also referred to as Msg3). The RRC message may include a radio resource control setup request (RRCSetupRequest, radio resource control connection setup request).

The first transmission number may be used to represent the number of times the terminal device continuously transmits the third access message.

It should be noted that continuous transmission may include initial transmission, repetition and retransmission. Retransmission may be transmission performed again in case of initial transmission failure. For example, if NACK corresponding to the initial transmission is received or ACK corresponding to the initial transmission is not received within a preset time, it indicates that the initial transmission has failed, and the initial transmission data may be transmitted again (retransmitted). The retransmission may use the same transmission parameter(s) (such as modulation and coding scheme) as the initial transmission, or the retransmission may different transmission parameters (such as modulation and coding schemes). Repetition may be a simple repetition of the initial transmission. For example, regardless of whether the initial transmission is successful, the initial transmission data is repeatedly transmitted, and the same transmission parameter as the initial transmission may be used.

The above-mentioned first transmission number may represent the number of repetitions of the third access message, or the number of retransmissions of the third access message, or the total number of repetitions and retransmissions of the third access message.

It should also be noted that the first transmission number may include the number of initial transmissions, or may not include the number of initial transmissions. For example, if the first transmission number represents the number of repetitions, the first transmission number is 3, which may represent 1 initial transmission+3 repetitions, or may represent 1 initial transmission+2 repetitions. The present disclosure does not impose any restrictions on this.

In this way, the terminal device can perform repetitions or retransmissions of the third access message according to the first transmission number, thereby improving the transmission reliability of the third access message and improving the access success rate.

In some embodiments, in the above step S502, the manner of determining the first transmission number for the terminal device to send the third access message may include one or more of the following:

Method 1: using a preset transmission times as the first transmission number.

For example, the preset transmission number may be a parameter preset in the terminal device, and the preset transmission number may be any value greater than or equal to 1, such as 3 or 5.

Method 2: obtaining a to-be-defined transmission parameter in the second access message; and determining the first transmission number according to the to-be-defined transmission parameter.

The to-be-defined transmission parameter may be one or more parameters. For example, the to-be-defined transmission parameter may include a first transmission parameter and/or a second transmission parameter.

In some embodiments, the second access message may include Downlink Control Information (DCI) for indicating uplink channel transmission, the first transmission parameter includes a Hybrid Automatic Repeat Request process number HARQ-Process-Number in the DCI, and the second transmission parameter may include a Redundancy Version (RV) in the DCI.

It should be noted that the DCI message in the second access message (Msg2) is used to indicate a transmission resource for the third access message (Msg3), according to the current 3GPP protocol, the HARQ-Process-Number used for Msg3 transmission can be fixed to 0, and thus the HARQ-Process-Number in the second access message (Msg2) is not currently used, and accordingly the HARQ-Process-Number can be reused as a to-be-defined transmission parameter. In addition, according to the current 3GPP protocol, the RV in the DCI is also a fixed value of 0, and thus the RV in the second access message (Msg2) is also not currently used, and accordingly the RV can also be reused as a to-be-defined transmission parameter.

In some embodiments, the terminal device may determine the first transmission number according to the second transmission parameter in a case where the first transmission parameter is a first preset parameter value.

The first preset value may be any preset value, for example, a preset value in which all bits are 1 or a preset value in which all bits are 0.

For example, the terminal device may determine the first transmission number according to RV in a case where all bits of HARQ-Process-Number are 1, for example, the terminal device may use the value of RV as the first transmission number.

In some other embodiments, the terminal device may determine the first transmission number according to the first transmission parameter in a case where the second transmission parameter is a second preset parameter value.

Likewise, the second preset value may be any preset value, for example, a preset value in which all bits are 1 or a preset value in which all bits are 0.

For example, the terminal device may determine the first transmission number according to the HARQ-Process-Number in a case where all bits of RV are 1, for example, the terminal device may use the value of the HARQ-Process-Number as the first transmission number.

In some other embodiments, in a case where the terminal device receives the first access parameter sent by the network device, or receives a first indication message sent by the network device, the terminal device determines the first transmission number according to the first parameter and/or the second parameter.

The first indication message is used to enable a Downlink Control Information format DCI 0-0 to control a dynamic repetition number.

For example, the value of the first parameter (e.g., HARQ-Process-Number) may be used as the first transmission number, or the value of the second parameter (e.g., RV) may be used as the first transmission number.

In some embodiments, determining the first transmission number according to the to-be-defined transmission parameter may include: using the value of the to-be-defined transmission parameter as the first transmission number.

For example, in a case where the to-be-defined transmission parameter includes HARQ-Process-Number, the value of HARQ-Process-Number can be used as the first transmission number; in a case where the to-be-defined transmission parameter includes RV, the value of RV can be used as the first transmission number.

In some other embodiments, determining the first transmission number according to the to-be-defined transmission parameter may include: determining the first transmission number corresponding to the to-be-defined transmission parameter according to a target transmission parameter corresponding relationship.

This method may include the following steps:

First, the target transmission parameter corresponding relationship is determined.

The target transmission parameter corresponding relationship includes a corresponding relationship between the to-be-defined transmission parameter and the first transmission number.

For example, a first to-be-defined transmission parameter corresponding relationship sent by a network device may be received, and the first to-be-defined transmission parameter corresponding relationship may be used as the target transmission parameter corresponding relationship. The first to-be-defined transmission parameter corresponding relationship is a corresponding relationship between the to-be-defined transmission parameter and the first transmission number determined by the network device.

For another example, a second to-be-defined transmission parameter corresponding relationship preset in the terminal device may be used as the target transmission parameter corresponding relationship. The second to-be-defined transmission parameter corresponding relationship is the same as a third to-be-defined transmission parameter corresponding relationship preset in the network device. The second transmission parameter corresponding relationship is a corresponding relationship between the to-be-defined transmission parameter and the first transmission number determined by the terminal device; the third transmission parameter corresponding relationship is a corresponding relationship between the to-be-defined transmission parameter and the first transmission number determined by the network device.

In this way, the network device and the terminal device use the same to-be-defined transmission parameter corresponding relationship to determine the same first transmission number, thereby achieving compatibility between the network device and the terminal device.

Then, according to the target transmission parameter corresponding relationship, the first transmission number corresponding to the to-be-defined transmission parameter is obtained.

For example, taking the to-be-defined transmission parameter being RV as an example, the value of RV may be any value from 0 to 3, and the target transmission parameter corresponding relationship may include a first transmission number of 1 corresponding to a RV value of 0, a first transmission number of 4 corresponding to a RV value of 1, a first transmission number of 8 corresponding to a RV value of 2, and a first transmission number of 16 corresponding to a RV value of 3. In this way, the first transmission number can be determined according to the value of the to-be-defined transmission parameter (RV).

It should be noted that the above values are examples, and different corresponding relationships can be set according to actual needs, and the present disclosure is not limited to this.

The terminal device can determine the first transmission number according to the to-be-defined transmission parameter and the target transmission parameter corresponding relationship, so as to transmit the third access message according to the first transmission number, thereby improving the transmission reliability of the third access message.

FIG. 6 is a communication method according to an example embodiment. The method may be applied to a network device. The method may include:

In S601, a first access message sent by a terminal device is received.

The first access message is a message sent by the terminal device to the network device according to a first polarization parameter of the terminal device to request access to the network device.

It should be noted that the first access message can be used by the terminal device to request access to the network device, and can also indicate the network device to process the access request of the terminal according to the first access message.

In S602, the first polarization parameter of the terminal device is obtained according to the first access message.

In some embodiments, the first access message may include a random access preamble (RA preamble, also known as Msg1). The first access message may be sent through a Physical Random Access Channel (PRACH). The terminal device may determine the PRACH resource corresponding to the first access message according to the first polarization parameter, and different first polarization parameters may correspond to different PRACH resources. In this way, the network device can also obtain the first polarization parameter of the terminal device according to the PRACH resource corresponding to the first access message.

In some other embodiments, for example, in a two-step random access (2-step RACH) scenario, the first access message may include MsgA, which may also be called a preamble.

By adopting the above method, the network device can receive the first access message sent by the terminal device, and obtain the first polarization parameter of the terminal device according to the first access message, thereby implicitly obtaining the first polarization parameter and improving the timeliness in obtaining the first polarization parameter by the network device.

In some embodiments, the first polarization parameter may be used to represent the antenna polarization type of the terminal device, and the antenna polarization type may be the polarization capability or polarization mode of the antenna of the terminal device. The antenna polarization type may include a circular polarization type and/or a linear polarization type. Further, the circular polarization type may include RHCP and/or LHCP, and the linear polarization type may include horizontal polarization and/or vertical polarization.

In a case where the antenna polarization type is the linear polarization type, the terminal device can determine a first PRACH resource corresponding to the linear polarization type, and transmit the first access message through the first PRACH resource. The network device can obtain the antenna polarization type of the terminal device which is the linear polarization type based on the first PRACH resource for receiving the first access message.

Similarly, when the antenna polarization type is the circular polarization type, the terminal device can determine a second PRACH resource corresponding to the circular polarization type, and transmit the first access message through the second PRACH resource. The network device can obtain the antenna polarization type of the terminal device which is a circular polarization type based on the second PRACH resource for receiving the first access message.

In this way, the network device can implicitly obtain the antenna polarization type of the terminal device according to the PRACH resource for transmitting the first access message.

It should also be noted that although the present disclosure uses linear polarization and circular polarization as examples, the present disclosure does not limit the antenna polarization type. For example, the antenna polarization type may also be other types than the above two polarization types, such as elliptical polarization, or linear polarization at a certain angle except horizontal polarization and vertical polarization.

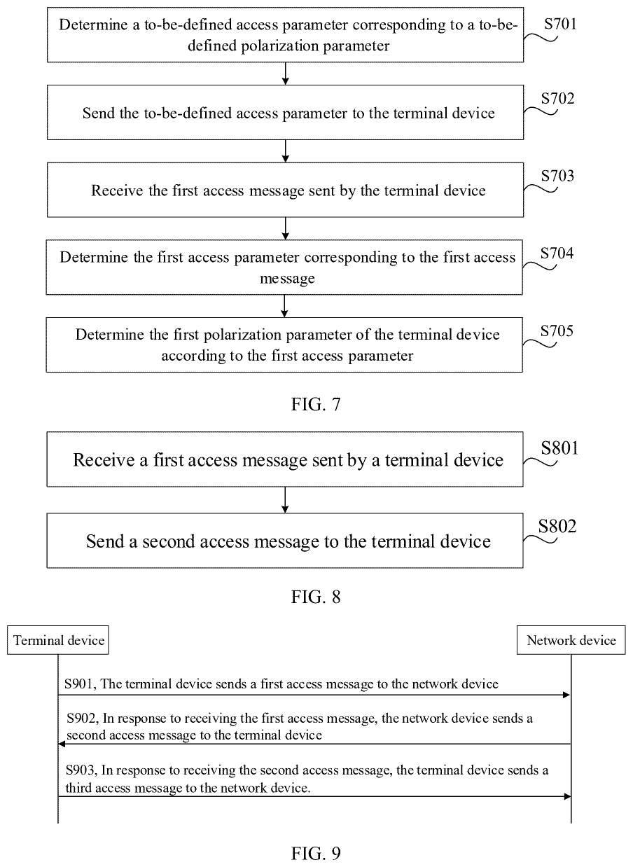

FIG. 7 is a communication method according to an example embodiment. The method may be applied in a network device. The method may include:

In S701, a to-be-defined access parameter corresponding to a to-be-defined polarization parameter is determined.

The to-be-defined polarization parameter may include a first polarization parameter, and the to-be-defined access parameter may also include a to-be-defined access parameter corresponding to the first polarization parameter. There may be one or more to-be-defined polarization parameters.

For example, the to-be-defined access parameter corresponding to the to-be-defined polarization parameter may be determined according a preset parameter of the network device, for example, the first access parameter corresponding to the first polarization parameter.

The above access parameter (the to-be-defined access parameter or the first access parameter) may represent a PRACH resource used to transmit the first access message. The PRACH resource may include one or more of the following resources: a physical random access channel root sequence (prach-RootSequence), a physical random access channel transmission occasion RO resource (PRACH transmission occasion, also referred to as PRACH occasion, RO resource for short), or a random access channel power resource, etc.

The above-mentioned to-be-defined polarization parameter may be used to represent the antenna polarization type, and the antenna polarization type can be the polarization capability or polarization mode of the antenna of the terminal device. The antenna polarization type may include a circular polarization type and/or a linear polarization type. Further, the circular polarization type may include RHCP and/or LHCP, and the linear polarization type may include horizontal polarization and/or vertical polarization. The above-mentioned preset parameter may include a corresponding relationship between to-be-defined polarization parameter(s) and to-be-defined access parameter(s), for example, a first to-be-defined access parameter corresponding to the linear polarization type, and a second to-be-defined access parameter corresponding to the circular polarization type. The first to-be-defined access parameter may represent that the first access message can be transmitted using the first PRACH resource, and the second to-be-defined access parameter can represent that the first access message is transmitted using the second PRACH resource.

In S702, the to-be-defined access parameter is sent to the terminal device.

The to-be-defined access parameter may be used to indicate the terminal device to obtain the first access parameter corresponding to the first polarization parameter and send the first access message to the network device according to the first access parameter.

In some embodiments, the network device may send the to-be-defined access parameter via a broadcast message, and the broadcast message may include a System Information Block (SIB) message. For example, the to-be-defined access parameter may be carried in a SIB message, the network device may send the to-be-defined access parameter via the SIB message, and the terminal device may receive the to-be-defined access parameter via the SIB message. In this way, when the terminal device accesses the network device, the terminal device may determine the first access parameter according to the to-be-defined access parameter received most recently, and send the first access message to the network device according to the first access parameter.

In some other embodiments, the network device may send the above-mentioned to-be-defined access parameter through a UE (User Equipment) dedicated message, and the UE dedicated message may include an RRC message. For example, the first access parameter may be carried in an RRC message, and after the terminal device accesses the network device and establishes an RRC connection, the network device may send the to-be-defined reception parameter through an RRC message, and the terminal device may receive the to-be-defined access parameter through the RRC message, and then after the RRC connection is released, when the terminal device accesses the network device again, the first access parameter may be determined according to the to-be-defined access parameter received most recently, and the first access message may be sent to the network device according to the first access parameter. The RRC message carrying the to-be-defined access parameter may be an RRC connection release (RRCRelease) message and/or an RRC reconfiguration (RRCReconfiguration) message.

In S703, the first access message sent by the terminal device is received.

In S704, the first access parameter corresponding to the first access message is determined.

By way of example, the first access parameter may be determined according to a PRACH resource for transmitting the first access message.

In S705, the first polarization parameter of the terminal device is determined according to the first access parameter.

For example, according to the corresponding relationship between the to-be-defined polarization parameter and the to-be-defined access parameter, the to-be-defined polarization parameter corresponding to the first access parameter may be determined, and the to-be-defined polarization parameter may be used as the first polarization parameter of the terminal device.

In this way, the terminal device sends the first access message to the network device according to the first access parameter received from the network device, the network device also determines the first access parameter according to the first access message, and determines the first polarization parameter of the terminal device according to the first access parameter. Through the interaction between the network device and the terminal device, the compatibility of the network device and the terminal device can be improved.

In some embodiments, different to-be-defined polarization parameters may correspond to different to-be-defined access parameters. For example, if the to-be-defined polarization parameter represents that the antenna polarization type of the terminal device is a linear polarization type, a first access parameter corresponding to the linear polarization type may be a first to-be-defined access parameter. The first to-be-defined access parameter may represent that the first access message may be transmitted using a first PRACH resource. Conversely, if the to-be-defined polarization parameter represents that the antenna polarization type of the terminal device is a circular polarization type, the to-be-defined access parameter corresponding to the circular polarization type may be a second to-be-defined access parameter. The second to-be-defined access parameter may represent that the first access message is transmitted using a second PRACH resource.

In some embodiments, the to-be-defined access parameters include one or more of the following parameters:
Parameter 1: a to-be-defined physical random access channel root sequence index prach-RootSequenceIndex corresponding to the to-be-defined polarization parameter.
Parameter 2: a to-be-defined physical random access channel generic configuration rach-ConfigGeneric corresponding to the to-be-defined polarization parameter;
Parameter 3: a to-be-defined synchronization signal block shared physical random access channel transmission occasion mask SSB-SharedRO-MaskIndex corresponding to the to-be-defined polarization parameter.

In some embodiments, the to-be-defined access parameter may be carried in a random access information element, and the random access information element includes one or more of the following information elements:
Information element 1: random access channel common configuration RACH-ConfigCommon information element;
Information element 2: random access channel common configuration information RACH-ConfigCommonTwoStepRA information element for two-step random access;
Information element 3: random access channel dedicated configuration information RACH-ConfigDedicated.

It should be noted that, for the specific description of the above-mentioned to-be-defined access parameter and random access information element, reference may be made to the description in the above-mentioned embodiments, and repeated description will be omitted here.

In some embodiments, the above step S602 may obtain the first polarization parameter of the terminal device in the following manner:

First, a second access parameter corresponding to the first access message is determined.

Secondly, according to the second polarization access parameter corresponding relationship preset in the network device, the first polarization parameter corresponding to the second access parameter is obtained.

The second polarization access parameter corresponding relationship includes a corresponding relationship between the first polarization parameter and the second access parameter, and the second polarization access parameter corresponding relationship is the same as a first polarization access parameter corresponding relationship preset in the terminal device.

By way of example, the second polarization access parameter corresponding relationship may include: a second access parameter corresponding to a linear polarization type; and a second access parameter corresponding to a circular polarization type.

In some embodiments, the second access parameter may represent a PRACH resource used to transmit the first access message, and the PRACH resource may also include one or more of the following resources: a physical random access channel root sequence (prach-RootSequence), a physical random access channel transmission occasion RO resource (PRACH transmission occasion, also referred to as PRACH occasion, RO resource for short), or a random access channel power resource, etc.

In this way, the same polarization access parameter corresponding relationship is preset in the terminal device and the network device, the terminal device sends the first access message according to the second access parameter, the network device can obtain the second access parameter according to the first access message, and obtain the first polarization parameter of the terminal device according to the second access parameter. The network device can implicitly obtain the first polarization parameter of the terminal device.

FIG. 8 is a communication method according to an example embodiment. The method may be applied to a network device. The method may include:

In S801, a first access message sent by a terminal device is received.

In this step, the first access message may be a first access message sent by the terminal device to the network device according to the first polarization parameter; or the terminal device may directly send a general first access message to the network device without considering the first polarization parameter, and this embodiment does not limit this.

In S802, a second access message is sent to the terminal device.

The second access message is configured to indicate the terminal device to determine a first transmission number for sending a third access message and send the third access message to the network device according to the first transmission number.

For example, in some embodiments, the first access message may include a random access preamble (RA preamble, also referred to as Msg1), the second access message may include a random access response (RAR, also referred to as Msg2), and the third access message may include a Radio Resource Control message (RRC message, also referred to as Msg3). The RRC message may include a radio resource control setup request (RRCSetupRequest, radio resource control connection setup request).

The first transmission number may be used to represent the number of times the terminal device continuously transmits the third access message. For example, the first transmission number may represent the number of repetitions of the third access message, or the number of retransmissions of the third access message, or the total number of repetitions and retransmissions of the third access message.

It should also be noted that the first transmission number may include the number of initial transmission(s), or may not include the number of initial transmission(s). For example, if the first transmission number represents the number of repetitions, the first transmission number is 3, which may represent 1 initial transmission+3 repetitions, or may represent 1 initial transmission+2 repetitions. The present disclosure does not impose any restrictions on this.

In this way, the network device can indicate the terminal device to perform repetitions or retransmissions of the third access message through the first transmission number, thereby improving the transmission reliability of the third access message and improving the access success rate.

In some embodiments, the above-mentioned S802 step may include: first determining the first transmission number according to the first polarization parameter and the second polarization parameter of the network device; then, determining a to-be-defined transmission parameter in the second access message according to the first transmission number, and sending the second access message to the terminal device.

For example, in a case where the first polarization parameter and the second polarization parameter are different, a first preset number of times may be used as the first transmission number; in a case where the first polarization parameter and the second polarization parameter are the same, a second preset number of times may be used as the first transmission number. The first preset number of times may be greater than or equal to the second preset number of times. In this way, in a case where the polarization parameters of the terminal device and the network device are different, the transmission reliability of the third access message can be improved by transmitting the third access message more times.

The second access message includes the above-mentioned to-be-defined transmission parameter. The to-be-defined transmission parameter may be one or more parameters. For example, the to-be-defined transmission parameter may include the first transmission parameter and/or the second transmission parameter.

In some embodiments, the second access message may include Downlink Control Information (DCI) for indicating uplink channel transmission, the first transmission parameter includes a Hybrid Automatic Repeat Request process number HARQ-Process-Number in the DCI, and the second transmission parameter may include a Redundancy Version (RV) in the DCI.

In some embodiments, the network device may use a value of the first preset parameter as the first transmission parameter, and determine the second transmission parameter according to the first transmission number.

The first preset value may be any preset value, for example, a preset value in which all bits are 1 or a preset value in which all bits are 0.

For example, the terminal device may determine the first transmission number according to RV in a case where all bits of HARQ-Process-Number are 1, for example, it may use the value of RV as the first transmission number.

In some other embodiments, the network device may use a value of the second preset parameter as the second transmission parameter, and determine the first transmission parameter according to the first transmission number.

Likewise, the second preset value may be any preset value, for example, a preset value in which all bits are 1 or a preset value in which all bits are 0.

For example, the terminal device may determine the first transmission number according to the HARQ-Process-Number in a case where all bits of RV are 1, for example, it may use the value of the HARQ-Process-Number as the first transmission number.

In some other embodiments, the network device may determine the first parameter and/or the second parameter according to the first transmission number in a case where the first access parameter is sent to the terminal device or a first indication message is sent to the terminal device. The first indication message is configured to enable the Downlink Control Information format DCI 0-0 to control a dynamic repetition number.

For example, the first transmission number may be used as the value of the first parameter (e.g., HARQ-Process-Number), or the first transmission number may be used as the value of the second parameter (e.g., RV).

In some embodiments, determining the to-be-defined transmission parameter in the second access message according to the first transmission number may include: using the first transmission number as the to-be-defined transmission parameter.

For example, in a case where the to-be-defined transmission parameter includes HARQ-Process-Number, the first transmission number may be used as the value of HARQ-Process-Number; in a case where the to-be-defined transmission parameter includes RV, the first transmission number may be used as the value of RV.

In some other embodiments, determining the to-be-defined transmission parameter in the second access message according to the first transmission number may include: obtaining the to-be-defined transmission parameter corresponding to the first transmission number according to a third to-be-defined transmission parameter corresponding relationship preset in the network device.

The third to-be-defined transmission parameter corresponding relationship includes a corresponding relationship between the to-be-defined transmission parameter and the first transmission number.

For example, taking the to-be-defined transmission parameter being RV as an example, the value of RV may be any value from 0 to 3, and the third to-be-defined transmission parameter corresponding relationship may include a first transmission number of 1 corresponding to RV value of 0, a first transmission number of 4 corresponding to RV value of 1, a first transmission number of 8 corresponding to RV value of 2, and a first transmission number of 16 corresponding to RV value of 3. In this way, the value of the to-be-defined transmission parameter (RV) can be determined according to the first transmission number.

It should be noted that the above values are examples, and different corresponding relationships can be set according to actual needs, and the present disclosure is not limited to this.

In some embodiments, the third to-be-defined transmission parameter corresponding relationship may be the same as the second to-be-defined transmission parameter corresponding relationship preset in the terminal device. The second to-be-defined transmission parameter is the corresponding relationship between the to-be-defined transmission parameter and the first transmission number determined by the terminal device.

In other embodiments, the third to-be-defined transmission parameter corresponding relationship may be used as the first to-be-defined transmission parameter corresponding relationship; the first to-be-defined transmission parameter corresponding relationship is sent to the terminal device; the first to-be-defined transmission parameter corresponding relationship is used to indicate the terminal device to obtain the target transmission parameter corresponding relationship according to the first to-be-defined transmission parameter corresponding relationship.

In this way, the network device and the terminal device use the same to-be-defined transmission parameter corresponding relationship to determine the same first transmission number, thereby achieving compatibility between the network device and the terminal device.

FIG. 9 is a communication method according to an example embodiment. The method may include:

In S901, a terminal device sends a first access message to a network device.

In some embodiments, a first access message may be sent to a network device according to a first polarization parameter of the terminal device. The first access message is used by the terminal device to request access to the network device, and is used by the network device to obtain the first polarization parameter according to the first access message.

For example, the terminal device may receive a to-be-defined access parameter corresponding to a to-be-defined polarization parameter sent by a network device, use the to-be-defined access parameter corresponding to the first polarization parameter of the terminal device as the first access parameter, and send the first access message to the network device according to the first access parameter.

For another example, the terminal device may determine the second access parameter corresponding to the first polarization parameter according to a preset first polarization access parameter corresponding relationship, and send the first access message to the network device according to the second access parameter.

The above access parameters (e.g., the to-be-defined access parameter, the first access parameter, or the second access parameter) may represent a PRACH resource used to transmit the first access message.

For example, the above access parameter (such as the to-be-defined access parameter, the first access parameter or the second access parameter) may include one or more of the following parameters:
Parameter 1: a physical random access channel root sequence index prach-RootSequenceIndex corresponding to the polarization parameter;
Parameter 2: a physical random access channel generic configuration rach-ConfigGeneric corresponding to the polarization parameter;
Parameter 3: synchronization signal block shared physical random access channel transmission occasion mask SSB-SharedRO-MaskIndex corresponding to the polarization parameter.

In this way, through the above-mentioned access parameter (such as the to-be-defined access parameter, the first access parameter or the second access parameter), the PRACH resources for sending the first access message can be determined, and the first access message can be sent through the PRACH resource, so that the first polarization parameter of the terminal device can be implicitly reported to the network device.

In some other embodiments, the terminal device may also directly send a general first access message to the network device without considering the first polarization parameter.

In S902, in response to receiving the first access message, the network device sends a second access message to the terminal device.

In S903, in response to receiving the second access message, the terminal device sends a third access message to the network device.

In some embodiments, the second access message may be configured to indicate the terminal device network device to send the third access message.

In some other embodiments, the second access message may be configured to indicate the terminal device to determine a first transmission number for the terminal device to send the third access message and send the third access message to the network device according to the first transmission number.

The first transmission number may be used to represent the number of times the terminal device continuously transmits the third access message. For example, the first transmission number may represent the number of repetitions of the third access message, or the number of retransmissions of the third access message, or the total number of repetitions and retransmissions of the third access message.

In this way, the network device can indicate the terminal device to perform repetitions or retransmissions of the third access message through the first transmission number, thereby improving the transmission reliability of the third access message and improving the access success rate.

In some embodiments, the network device may first determine the first transmission number according to the first polarization parameter and the second polarization parameter of the network device; then, the network device determines the to-be-defined transmission parameter in the second access message according to the first transmission number, and sends the second access message to the terminal device.

The second access message includes the above-mentioned to-be-defined transmission parameter. The to-be-defined transmission parameter may be one or more parameters. For example, the to-be-defined transmission parameter may include the first transmission parameter and/or the second transmission parameter.

In some embodiments, the second access message may include Downlink Control Information (DCI) for indicating uplink channel transmission, the first transmission parameter includes a Hybrid Automatic Repeat Request process number HARQ-Process-Number in the DCI, and the second transmission parameter may include a Redundancy Version (RV) in the DCI.

In some embodiments, the first access message may include a random access preamble (RA preamble, also referred to as Msg1), the second access message may include a random access response (RAR, also referred to as Msg2), and the third access message may include a Radio Resource Control message (RRC message, also referred to as Msg3). The RRC message may include a radio resource control setup request (RRCSetupRequest, radio resource control connection setup request).

In some other embodiments, for example, in a two-step random access (2-step RACH) scenario, the first access message may include MsgA, which may also be called a preamble, and the second access message may include MsgB. In this case, the S903 step may not be performed, and the terminal device can access the network device through the first access message and the second access message.

In this way, the network device can indicate the terminal device to perform repetitions or retransmissions of the third access message through the first transmission number, thereby improving the transmission reliability of the third access message and improving the access success rate.

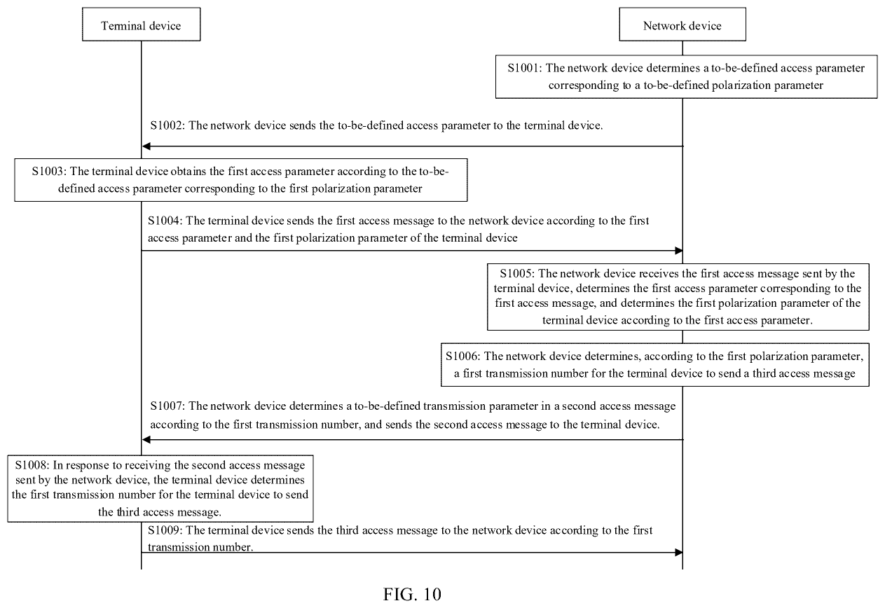

FIG. 10 is a communication method according to an example embodiment, and the method may include:

In S1001, a network device determines a to-be-defined access parameter corresponding to a to-be-defined polarization parameter.

The to-be-defined polarization parameter may include a first polarization parameter, and the to-be-defined access parameter may also include a to-be-defined access parameter corresponding to the first polarization parameter. There may be one or more to-be-defined polarization parameters.

For example, the to-be-defined access parameter corresponding to the to-be-defined polarization parameter may be determined according to a preset parameter of the network device, for example, a first access parameter corresponding to the first polarization parameter. The above access parameter (the to-be-defined access parameter or the first access parameter) may represent a PRACH resource used to transmit the first access message. The PRACH resource may include one or more of the following resources: a physical random access channel root sequence (prach-RootSequence), a physical random access channel transmission occasion RO resource (PRACH transmission occasion, also referred to as PRACH occasion, or called RO resource for short), or a random access channel power resource, etc.

In S1002, the network device sends the to-be-defined access parameter to the terminal device.

The to-be-defined access parameter may be used to indicate the terminal device to obtain the first access parameter corresponding to the first polarization parameter and send a first access message to the network device according to the first access parameter.

In S1003, the terminal device obtains the first access parameter according to the to-be-defined access parameter corresponding to the first polarization parameter.

For example, the terminal device may use the to-be-defined access parameter corresponding to the first polarization parameter as the first access parameter.

In S1004, the terminal device sends the first access message to the network device according to the first access parameter and the first polarization parameter of the terminal device.

In S1005, the network device receives the first access message sent by the terminal device, determines the first access parameter corresponding to the first access message, and determines the first polarization parameter of the terminal device according to the first access parameter.

In S1006, the network device determines, according to the first polarization parameter, a first transmission number for the terminal device to send a third access message.

In S1007, the network device determines a to-be-defined transmission parameter in a second access message according to the first transmission number, and sends the second access message to the terminal device.

In S1008, in response to receiving the second access message sent by the network device, the terminal device determines the first transmission number for the terminal device to send the third access message.

In S1009, the terminal device sends the third access message to the network device according to the first transmission number.

By adopting the above method, the terminal device can implicitly report the first polarization parameter of the terminal device through the first access message. The network device can determine the first transmission number for the terminal device to send the third access message based on the first polarization parameter, and indicate the terminal to send the third access message according to the first transmission number through the second access message (Mg2). In this way, the embodiment can realize implicit reporting of the first polarization parameter of the terminal device, and can achieve the purpose of controlling the repetition(s) or retransmission(s) of the third access message, thereby improving the success rate for the terminal device to access to the network device.

FIG. 11 is a block diagram of a communication apparatus 1100 according to an example embodiment. The apparatus 1100 may be applied in a terminal device. As shown in FIG. 11, the apparatus 1100 may include: a first parameter determination module 1101 and a first message sending module 1102.

The first parameter determination module 1101 is configured to determine a first polarization parameter of the terminal device.

The first message sending module 1102 is configured to send a first access message to a network device according to the first polarization parameter, where the first access message is configured to indicate the network device to obtain the first polarization parameter according to the first access message.

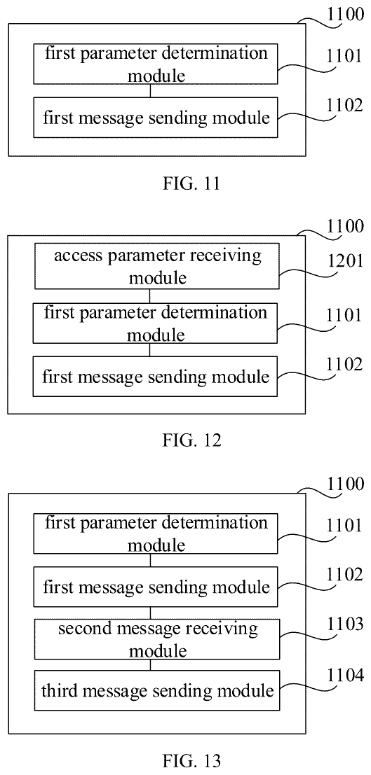

FIG. 12 is a block diagram of a communication apparatus 1100 according to an example embodiment. As shown in FIG. 12, the device may further include: a access parameter receiving module 1201.

The access parameter receiving module 1201 is configured to receive a to-be-defined access parameter corresponding to a to-be-defined polarization parameter sent by the network device, where the to-be-defined polarization parameter includes the first polarization parameter;

the first message sending module 1102 is configured to: determine a first access parameter corresponding to the first polarization parameter; and use the to-be-defined access parameter corresponding to the first polarization parameter as the first access parameter.

Optionally, the to-be-defined access parameter is carried in a random access information element, and the random access information element includes one or more of the following information elements:
a random access channel common configuration RACH-ConfigCommon information element;
a random access channel common configuration information for two-step random access RACH-ConfigCommonTwoStepRA information element;
a random access channel dedicated configuration information RACH-ConfigDedicated.

Optionally, the to-be-defined access parameter includes one or more of the following parameters:
a to-be-defined physical random access channel root sequence index prach-RootSequenceIndex corresponding to the to-be-defined polarization parameter;
a to-be-defined physical random access channel generic configuration rach-ConfigGeneric corresponding to the to-be-defined polarization parameter;
a to-be-defined synchronization signal block shared physical random access channel transmission occasion mask SSB-SharedRO-MaskIndex corresponding to the to-be-defined polarization parameter.

Optionally, the first message sending module 1102 is configured to determine, according to a first polarization access parameter corresponding relationship preset in the terminal device, a second access parameter corresponding to the first polarization parameter; where the first polarization access parameter corresponding relationship includes a corresponding relationship between the first polarization parameter and the second access parameter, and the first polarization access parameter corresponding relationship is the same as a second polarization access parameter corresponding relationship preset in the network device; and according to the second access parameter, send the first access message to the network device.

Optionally, the first polarization parameter is used to represent an antenna polarization type of the terminal device, and the antenna polarization type includes a circular polarization type and/or a linear polarization type.

FIG. 13 is a block diagram of a communication apparatus 1100 according to an example embodiment. As shown in FIG. 13, the apparatus may further include: a second message receiving module 1103 and a third message sensing module 1104.

The second message receiving module 1103 is configured to determine a first transmission number for the terminal device to send the third access message in response to receiving the second access message sent by the network device;
the third message sending module 1104 is configured to send the third access message to the network device according to the first transmission number.

Optionally, the second message receiving module 1103 is configured to obtain a to-be-defined transmission parameter in the second access message; and determine the first transmission number according to the to-be-defined transmission parameter.

Optionally, the to-be-defined transmission parameter includes a first transmission parameter and/or a second transmission parameter.

Optionally, the second access message includes Downlink Control Information (DCI) for indicating uplink channel transmission, the first transmission parameter includes a Hybrid Automatic Repeat Request process number HARQ-Process-Number in the DCI, and the second transmission parameter includes a Redundancy Version (RV) in the DCI.

Optionally, in a case where the to-be-defined transmission parameter includes the first transmission parameter and the second transmission parameter, the second message receiving module 1103 is configured to: determine the first transmission number according to the second transmission parameter in a case where the first transmission parameter is a first preset parameter value; or determine the first transmission number according to the first transmission parameter in a case where the second transmission parameter is a second preset parameter value.

Optionally, the second message receiving module 1103 is configured to determine the first transmission number according to the first parameter and/or the second parameter in a case where the first access parameter sent by the network device is received, or in a case where a first indication message sent by the network device is received, where the first indication message is configured to enable a Downlink Control Information format DCI 0-0 to control a dynamic repetition number.

Optionally, the second message receiving module 1103 is configured to use a value of the to-be-defined transmission parameter as the first transmission number.

Optionally, the second message receiving module 1103 is configured to: determine a target transmission parameter corresponding relationship, where the target transmission parameter corresponding relationship includes a corresponding relationship between the to-be-defined transmission parameter and the first transmission number; and
according to the target transmission parameter corresponding relationship, obtain the first transmission number corresponding to the to-be-defined transmission parameter.

Optionally, the second message receiving module 1103 is configured to: receive a first to-be-defined transmission parameter corresponding relationship sent by the network device; and
use the first to-be-defined transmission parameter corresponding relationship as the target transmission parameter corresponding relationship.

Optionally, the second message receiving module 1103 is configured to use the second to-be-defined transmission parameter corresponding relationship preset in the terminal device as the target transmission parameter corresponding relationship, where the second to-be-defined transmission parameter corresponding relationship is the same as a third to-be-defined transmission parameter corresponding relationship preset in the network device.

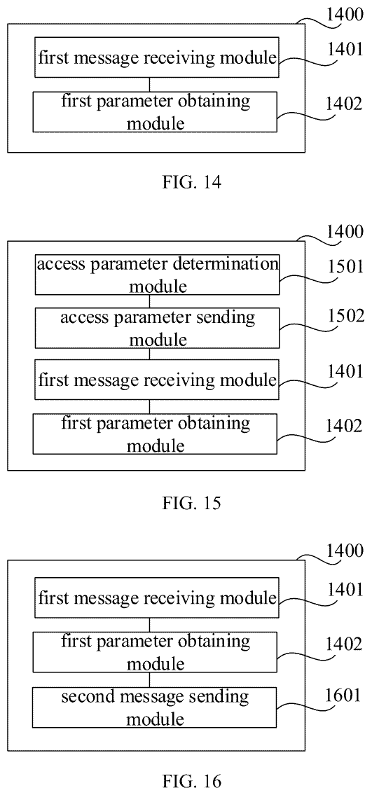

FIG. 14 is a block diagram of a communication apparatus 1400 according to an example embodiment. The apparatus 1400 may be applied in a network device. As shown in FIG. 14, the apparatus 1400 may include: a first message receiving module 1401 and a first parameter obtaining module 1402.

The first message receiving module 1401 is configured to receive a first access message, where the first access message is a message sent by a terminal device to the network device according to a first polarization parameter of the terminal device to request access to the network device;
the first parameter obtaining module 1402 is configured to obtain the first polarization parameter of the terminal device according to the first access message.

FIG. 15 is a block diagram of a communication apparatus 1400 according to an example embodiment. As shown in FIG. 15, the apparatus may further include: an access parameter determination module 1501 and an access parameter sending module 1502.

The access parameter determination module 1501 is configured to determine a to-be-defined access parameter corresponding to a to-be-defined polarization parameter, where the to-be-defined polarization parameter includes the first polarization parameter;
the access parameter sending module 1502 is configured to send the to-be-defined access parameter to the terminal device, where the to-be-defined access parameter is configured to indicate the terminal device to use the to-be-defined access parameter corresponding to the first polarization parameter as the first access parameter and send the first access message to the network device according to the first access parameter;
the first parameter acquisition module 1402 is configured to determine the first access parameter corresponding to the first access message, and determine the first polarization parameter of the terminal device according to the first access parameter.

Optionally, the to-be-defined access parameter is carried in a random access information element, and the random access information element includes one or more of the following information elements:
a random access channel common configuration RACH-ConfigCommon information element;
a random access channel common configuration information for two-step random access RACH-ConfigCommonTwoStepRA information element;
a random access channel dedicated configuration information RACH-ConfigDedicated.

Optionally, the to-be-defined access parameter includes one or more of the following parameters:
a to-be-defined physical random access channel root sequence index prach-RootSequenceIndex corresponding to the to-be-defined polarization parameter;
a to-be-defined physical random access channel generic configuration rach-ConfigGeneric corresponding to the to-be-defined polarization parameter;
a to-be-defined synchronization signal block shared physical random access channel transmission occasion mask SSB-SharedRO-MaskIndex corresponding to the to-be-defined polarization parameter.

Optionally, the first parameter obtaining module 1402 is configured to: determine a second access parameter corresponding to the first access message; and obtain the first polarization parameter corresponding to the second access parameter according to a second polarization access parameter corresponding relationship preset in the network device; where the second polarization access parameter corresponding relationship includes a corresponding relationship between the first polarization parameter and the second access parameter, and the second polarization access parameter corresponding relationship is the same as the first polarization access parameter corresponding relationship preset in the terminal device.

Optionally, the first polarization parameter is configured to represent an antenna polarization type of the terminal device, and the antenna polarization type includes a circular polarization type and/or a linear polarization type.

FIG. 16 is a block diagram of a communication apparatus 1400 according to an example embodiment. As shown in FIG. 16, the apparatus may further include: a second message sending module 1601.

The second message sending module 1601 is configured to send a second access message to the terminal device, where the second access message is configured to indicate the terminal device to determine a first transmission number for sending a third access message and send the third access message to the network device according to the first transmission number.

Optionally, the second message sending module 1601 is configured to: determine the first transmission number according to the first polarization parameter and the second polarization parameter of the network device; and determine the to-be-defined transmission parameter in the second access message according to the first transmission number; and send the second access message to the terminal device.

Optionally, the to-be-defined transmission parameter includes a first transmission parameter and/or a second transmission parameter.

Optionally, the second access message includes Downlink Control Information (DCI) for indicating uplink channel transmission, the first transmission parameter includes a Hybrid Automatic Repeat Request process number HARQ-Process-Number in the DCI, and the second transmission parameter includes a Redundancy Version (RV) in the DCI.

Optionally, in a case where the to-be-defined transmission parameter includes the first transmission parameter and the second transmission parameter, the second message sending module 1601 is configured to: use a first preset parameter value as the first transmission parameter, and determine the second transmission parameter according to the first transmission number; or, use a second preset parameter value as the second transmission parameter, and determine the first transmission parameter according to the first transmission number.

Optionally, the second message sending module 1601 is configured to determine the first parameter and/or the second parameter according to the first transmission number in a case where the first access parameter is sent to the terminal device, or in a case where a first indication message is sent to the terminal device, where the first indication message is configured to enable a Downlink Control Information format DCI 0-0 to control a dynamic repletion number.

Optionally, the second message sending module 1601 is configured to use the first transmission number as the to-be-defined transmission parameter.

Optionally, the second message sending module 1601 is configured to obtain the to-be-defined transmission parameters corresponding to the first transmission number according to a third to-be-defined transmission parameter corresponding relationship preset in the network device, where the third to-be-defined transmission parameter corresponding relationship includes the corresponding relationship between the to-be-defined transmission parameter and the first transmission number.

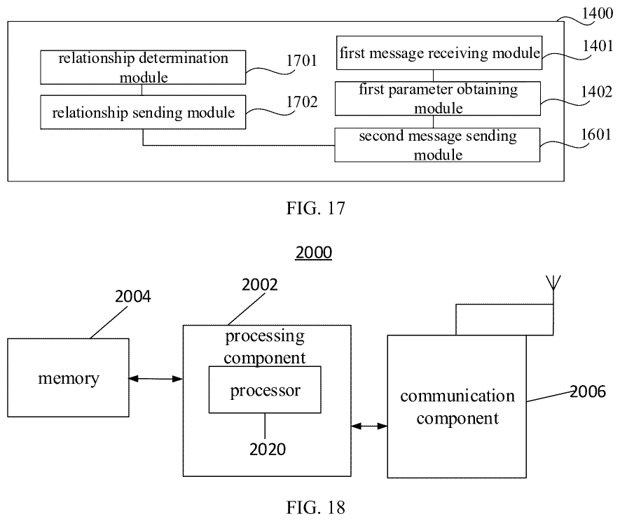

FIG. 17 is a block diagram of a communication apparatus 1400 according to an example embodiment. As shown in FIG. 17, the apparatus may further include: a relationship determination module 1701 and a relationship sending module 1702.

The relationship determination module 1701 is configured to use the third to-be-defined transmission parameter corresponding relationship as the first to-be-defined transmission parameter corresponding relationship;
the relationship sending module 1702 is configured to send the first to-be-defined transmission parameter corresponding relationship to the terminal device, where the first to-be-defined transmission parameter corresponding relationship is configured to indicate the terminal device to obtain a target transmission parameter corresponding relationship according to the first to-be-defined transmission parameter corresponding relationship.

Optionally, the third to-be-defined transmission parameter corresponding relationship is the same as the second to-be-defined transmission parameter corresponding relationship preset in the terminal device.

Optionally, the second message sending module 1601 is configured to: use the first preset number of times as the first transmission number in a case where the first polarization parameter and the second polarization parameter are different; and use the second preset number of times as the first transmission number in a case where the first polarization parameter and the second polarization parameter are the same, wherein the first preset number of times is greater than or equal to the second preset number of times.

Regarding the apparatus in the above embodiments, the specific manner in which each module performs operations has been described in detail in the embodiments of the methods, and will not be elaborated here.

FIG. 18 is a block diagram of a communication apparatus 2000 according to an example embodiment. For example, the communication apparatus 2000 may be a terminal device, for example, a mobile phone, a computer, digital broadcast terminal, a messaging device, a gaming console, a tablet, a medical device, exercise equipment, a personal digital assistant, and the like; the communication apparatus 2000 may also the network device described above. The communication apparatus 2000 may also be a server.

Referring to FIG. 18, the apparatus 2000 may include one or more of the following components: a processing component 2002, a memory 2004, and a communication component 2006.

The processing component 2002 typically controls overall operations of the apparatus 2000, such as the operations associated with display, telephone calls, data communications, camera operations, and recording operations. The processing component 2002 may include one or more processors 2020 to execute instructions to perform all or part of the steps in the above described communication methods. Moreover, the processing component 2002 may include one or more modules which facilitate the interaction between the processing component 2002 and other components. For instance, the processing component 2002 may include a multimedia module to facilitate the interaction between the multimedia component and the processing component 2002.

The memory 2004 is configured to store various types of data to support the operation of the apparatus 2000. Examples of such data include instructions for any applications or methods operated on the apparatus 2000, contact data, phonebook data, messages, pictures, video, etc. The memory 2004 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The communication component 2006 is configured to facilitate communication, wired or wirelessly, between the apparatus 2000 and other devices. The apparatus 2000 can access a wireless network based on a communication standard, such as WiFi, 2G, or 3G, or a combination thereof. In one example embodiment, the apparatus 2000 receives a broadcast signal or broadcast associated information from an external broadcast management system via a broadcast channel. In one example embodiment, the communication component 2006 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the apparatus 2000 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described communication methods.

In addition to being an independent electronic device, the above described apparatus 2000 can also be a part of an independent electronic device. For example, in one embodiment, the electronic device can be an Integrated Circuit (IC) or a chip, and the integrated circuit can be an IC or a collection of multiple ICs. The chip can include but is not limited to the following types: Graphics Processing Unit (GPU), Central Processing Unit (CPU), Field Programmable Gate Array (FPGA), Digital Signal Processor (DSP), Application Specific Integrated Circuit (ASIC), System on Chip (SoC, or system level chip), etc. The above described integrated circuit or chip can be used to execute executable instructions (or codes) to implement the above described communication methods. The executable instructions can be stored in the integrated circuit or chip, or can be obtained from other devices or equipment, for example, the integrated circuit or chip includes a processor, a memory, and an interface for communicating with other device(s). The executable instructions can be stored in the processor, and when the executable instructions are executed by the processor, the above described communication methods are implemented. Alternatively, the integrated circuit or chip may receive the executable instructions through the interface and transmit them to the processor for execution, so as to implement the above described communication methods.

In example embodiments, there is also provided a non-transitory computer-readable storage medium including instructions, such as the memory 2004 including instructions executable by the processor 2020 in the apparatus 2000, for performing the above-described communication methods. For example, the non-transitory computer-readable storage medium may be a ROM, a Random Access Memory (RAM), a CD-ROM, a magnetic tape, a floppy disc, an optical data storage device, and the like.

In another example embodiment, a computer program product is also provided. The computer program product includes a computer program executable by a programmable apparatus, and the computer program has a code portion for executing the above communication methods when executed by the programmable apparatus.

Other embodiments of the present disclosure will be apparent to those skilled in the art from consideration of the specification and practice of the disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

1. A communication method, wherein the method is performed by a terminal device and comprises:
determining a first polarization parameter of the terminal device; and
sending a first access message to a network device according to the first polarization parameter, wherein the first access message is configured to indicate the network device to obtain the first polarization parameter according to the first access message.

2. The method according to claim 1, further comprising:
receiving from the network device at least one access parameter corresponding to at least one polarization parameter, wherein the at least one polarization parameter comprises the first polarization parameter;
wherein sending the first access message to the network device according to the first polarization parameter comprises:
determining an access parameter corresponding to the first polarization parameter as the first access parameter; and
sending the first access message to the network device according to the first access parameter.

3. The method according to claim 2, wherein the at least one access parameter is carried in a random access information element, and the random access information element comprises one or more of:
a random access channel common configuration RACH-ConfigCommon information element;
a random access channel common configuration information for two-step random access RACH-ConfigCommonTwoStepRA information element; or
a random access channel dedicated configuration information RACH-ConfigDedicated.

4. The method according to claim 2, wherein the at least one access parameter received from the network device comprises one or more of:
a physical random access channel root sequence index prach-RootSequenceIndex corresponding to the first polarization parameter;
a physical random access channel generic configuration rach-ConfigGeneric corresponding to the first polarization parameter; or
a synchronization signal block shared physical random access channel transmission occasion mask SSB-SharedRO-MaskIndex corresponding to the first polarization parameter.

5. The method according to claim 1, wherein sending the first access message to the network device according to the first polarization parameter comprises:
according to a first corresponding relationship preset in the terminal device, determining a second access parameter corresponding to the first polarization parameter, wherein the first corresponding relationship comprises a corresponding relationship between the first polarization parameter and the second access parameter, and the first corresponding relationship is the same as a second corresponding relationship preset in the network device; and
sending the first access message to the network device according to the second access parameter.

6. The method according to claim 1, wherein the first polarization parameter is configured to represent an antenna polarization type of the terminal device, and the antenna polarization type comprises at least one of a circular polarization type or a linear polarization type.

7. The method according to claim 1, further comprising:
in response to receiving a second access message sent by the network device, determining a first transmission number for the terminal device to a third access message; and
sending the third access message to the network device according to the first transmission number.

8. The method according to claim 7, wherein in response to receiving the second access message sent by the network device, determining the first transmission number for the terminal device to send the third access message comprises:
obtaining a transmission parameter in the second access message; and
determining the first transmission number according to the transmission parameter.

9. The method according to claim 8, wherein the transmission parameter comprises at least one of a first transmission parameter or a second transmission parameter.

10. The method according to claim 9, wherein the second access message comprises Downlink Control Information (DCI) for indicating uplink channel transmission, the first transmission parameter comprises a Hybrid Automatic Repeat Request process number HARQ-Process-Number in the DCI, and the second transmission parameter comprises a Redundancy Version (RV) in the DCI.

11. The method according to claim 9, wherein in response to the transmission parameter comprising the first transmission parameter and the second transmission parameter, determining the first transmission number comprises:
in response to the first transmission parameter being a first preset parameter value, determining the first transmission number according to the second transmission parameter; or
in response to the second transmission parameter being a second preset parameter value, determining the first transmission number according to the first transmission parameter.

12. The method according to claim 9, wherein determining the first transmission number comprises:
in response to the first access parameter sent by the network device being received, or in response to a first indication message sent by the network device being received, determining the first transmission number according to at least one of the first transmission parameter or the second transmission parameter, wherein the first indication message is configured to enable a Downlink Control Information format DCI 0-0 to control a dynamic repetition number.

13. The method according to claim 8, wherein determining the first transmission number comprises:
determining a value of the transmission parameter as the first transmission number.

14. The method according to claim 8, wherein determining the first transmission number comprises:
determining a target transmission parameter corresponding relationship, wherein the target transmission parameter corresponding relationship comprises a corresponding relationship between the transmission parameter and the first transmission number; and
according to the target transmission parameter corresponding relationship, obtaining the first transmission number corresponding to the transmission parameter.

15. The method according to claim 14, wherein determining the target transmission parameter corresponding relationship comprises:
receiving a first transmission parameter corresponding relationship sent by the network device; and
determining the first transmission parameter corresponding relationship as the target transmission parameter corresponding relationship.

16. The method according to claim 14, wherein determining the target transmission parameter corresponding relationship comprises:
determining a second transmission parameter corresponding relationship preset in the terminal device as the target transmission parameter corresponding relationship, wherein the second transmission parameter corresponding relationship is the same as a third transmission parameter corresponding relationship preset in the network device.

17. A communication method, wherein the method is performed by a network device and the method comprises:
receiving a first access message, wherein the first access message is a message sent by a terminal device to a network device according to a first polarization parameter of the terminal device to request access to the network device; and
obtaining the first polarization parameter of the terminal device according to the first access message.

18.-35. (canceled)

36. A terminal device, comprising:
a processor; and
a memory configured to store instructions executable by the processor;
wherein the processor is configured to:
determine a first polarization parameter of the terminal device; and
send a first access message to a network device according to the first polarization parameter, wherein the first access message is configured to indicate the network device to obtain the first polarization parameter according to the first access message.

37. A network device, comprising:
a processor;
a memory configured to store instructions executable by the processor;
wherein the processor is configured to perform steps of the method according to claim 17.

38. A non-transitory computer-readable storage medium having computer program instructions stored thereon, wherein when the computer program instructions are executed by a processor, steps of the method according to claim 1.

39. (canceled)
